(19) United States
(12) Patent Application Publication
(10) Pub. No.: US 2020/0128224 A1
(43) Pub. Date: Apr. 23, 2020

(54) COMPUTER IMPLEMENTED METHOD OF CAPTURING STEREO IMAGES USING SINGLE LENS OPTICS OF ANY SMART DEVICE WITHOUT THE USE OF ANY ADDITIONAL HARDWARE

(71) Applicant: Brian W. Bush, Dafter, MI (US)

(72) Inventor: Brian W. Bush, Dafter, MI (US)

(21) Appl. No.: 16/536,700

(22) Filed: Aug. 9, 2019

Related U.S. Application Data
(60) Provisional application No. 62/747,381, filed on Oct. 18, 2018.

(51) Int. Cl. H04N 13/207

(52) U.S. Cl. CPC H04N 13/207

(57) ABSTRACT

Provided is a computer implemented system of capturing stereo images using the single lens optics of any smart device without the use of any additional hardware. The systemic software application embodied by the system utilizes the image capturing functionality of the smart device via a pan mode to capture a right and left eye perspective images of a desired initial image capture. The user first establishes an initial focal point associated with the initial image capture, and then pans left and right thereof within a selected range that frames the initial image capture. The systemic application is adapted to use the existing capabilities of the smart device to define two corresponding right and left eye images from the respective right and left eye perspective view, respectively, for composing a stereo image from other functionality of the smart device.

### CROSS-REFERENCE TO RELATED APPLICATION

This application claims the benefit of priority of U.S. provisional application No. 62/747,381, filed 18 Oct., 2018 the contents of which are herein incorporated by reference.

### BACKGROUND OF THE INVENTION

The present invention relates to stereo image photography and, more particularly, to a computer implemented method of capturing stereo images using the single lens optics of any smart device without the use of any additional hardware.

Smart device, such as smart phones and smart pads, have cameras providing only a single lens, limiting them to capturing only two-dimensional images or photos. Thus, by themselves, a vast majority of smart devices are incapable of taking true stereo images. Other stereo photo systems require the use of special stereo photo equipment. In other words, stereo photography via a standard smart device having only single lens optics requires specially designed stereo camera hardware and equipment to produce stereo photos. Which is unfortunate as everyone already owns and carries a smart device, yet the addition of additional equipment and hardware to take stereo photos is too burdensome for most to bother with and/or would be prohibitively expensive.

As can be seen, there is a need for a computer implemented method of capturing stereo image using single lens optics of any smart device without the use of any additional hardware. Thus, a user may simply add a software application of system embodied in the present invention to their existing smart device, enabling the use of the smart device to capture stereo images using only the camera's existing single lens, computer and memory capabilities, without the requirement of adding additional or changing preexisting hardware.

Accordingly, the present invention improves the technology of smart phone, computer-based photography through the disclosed computer-implemented methodology.

### SUMMARY OF THE INVENTION

In one aspect of the present invention, a computer implemented method for capturing stereo images using the single lens optics of any smart device without the use of any additional hardware, including the following: providing a smart device having a camera; selectively defining a focal point associated with an initial image capture by way of the camera; capturing sequential images left and right of said focal point by a predetermined range through the camera, defining a left eye perspective image and a right eye perspective image of the initial image capture; and composing said left and right eye perspective images into a left and right eye image, respectively, whereby said left and right eye image are configurable as a stereo image.

In another aspect of the present invention, the above-mentioned method may include wherein the capturing of sequential images is from a pan or video mode of the camera, and wherein the predetermined range is between two and twelve inches.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, illustrating an initial image capture 10;

FIG. 2 is an elevation view of an exemplary embodiment of the present invention, demonstrating the process of capturing a left eye perspective image and a right eye perspective image through a panning mode;

FIG. 3 is a schematic view of an exemplary embodiment of the present invention utilizing the internet 22;

FIG. 4 is a schematic view of an exemplary embodiment of the present invention, demonstrating the capturing of a left and right perspective images via a video mode for producing a short stereo video image or even a 360-degree stereo image for a virtual reality viewer;

FIG. 5 is a flow chart of an exemplary embodiment of the present invention; and

FIG. 6 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a computer implemented method of capturing stereo images using the single lens optics of any smart device without the use of any additional hardware. The present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include a systemic application on a smart device. The software may be accessed by the computer using a web browser. The computer may access the systemic software via the web browser using the internet 22, extranet, intranet, host server, internet cloud 22 and the like.

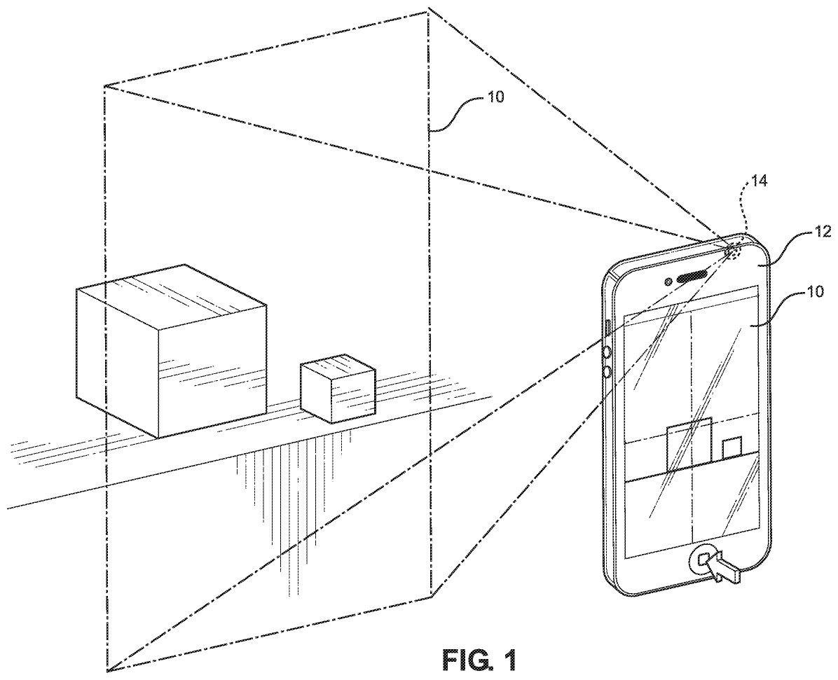

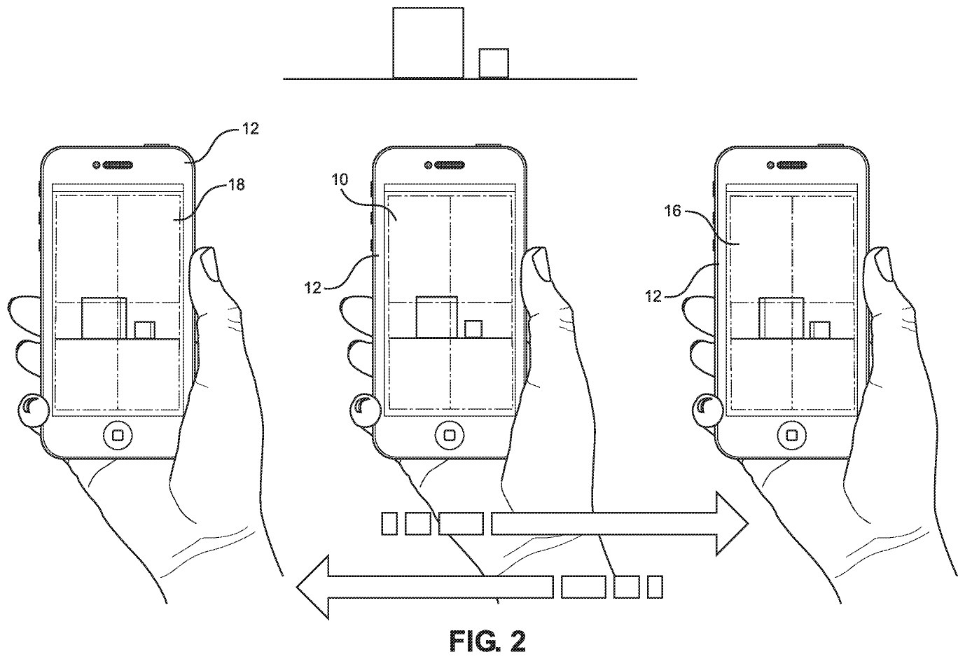

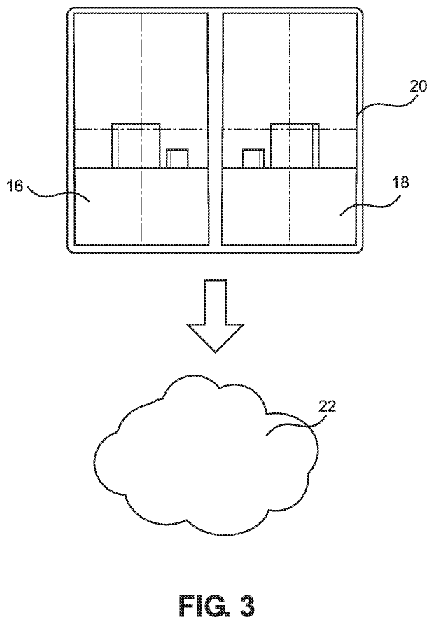

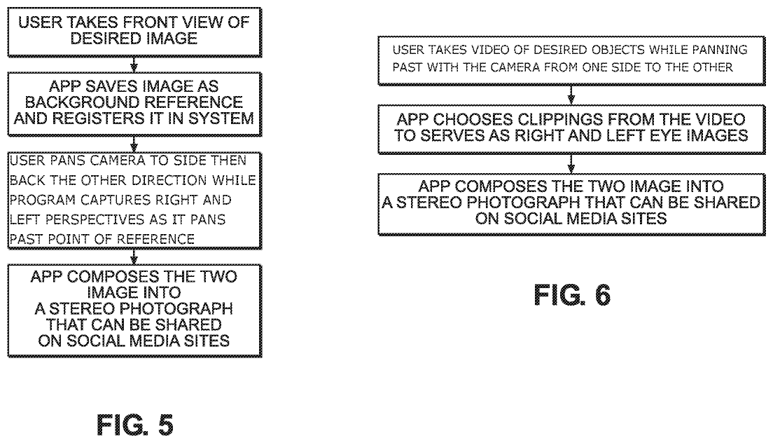

Referring to FIGS. 1 through 6, the systemic application of the present invention enables, in conjunction with the existing smart phone's 12 photography capabilities/camera 14, a process of positioning the smart devices' 12 image-capturing capabilities/camera 14 to record a two or more captured-image perspectives for each eye (i.e., right and left eye perspective images, respectively) as the camera's 14 view passes the selected scene. The systemic application is adapted to compose a left eye image 16 and a right eye image 18 from the two or more captured-image perspectives. In the processes of capturing the two or more right and left eye perspectives images, the user would select an initial focal point and surrounding range when framing the to-be-captured image/initial image capture 10. Specifically, the systemic application is adapted to use the existing capabilities of the smart device 12 to selectively capture two corresponding right and left eye perspective images as the camera 14 operatively associated with the smart device 12 is panned past the selected framed scene/initial image capture 10 in the camera's panning mode, see FIGS. 2 and 5. For instance, the user initially frames the desired scene/initial image capture 10, presses the ‘shutter button’ and then pans the camera to one side then back past original camera position (focal point of the scene/initial image capture 10) at which point the systemic application is adapted to enable the camera to capture the corresponding right/left eye perspective images and compose the compose the left eye image 16 and the right eye image 18 therefrom. The user would have the left eye image 16 and the right eye image 18 available to view in their chosen stereo image and/or 3D format

Thereafter, the systemic application uses the smart device's computer and memory capabilities to store, recall, view and share the reconfigured images in various two or three-dimensional formats.

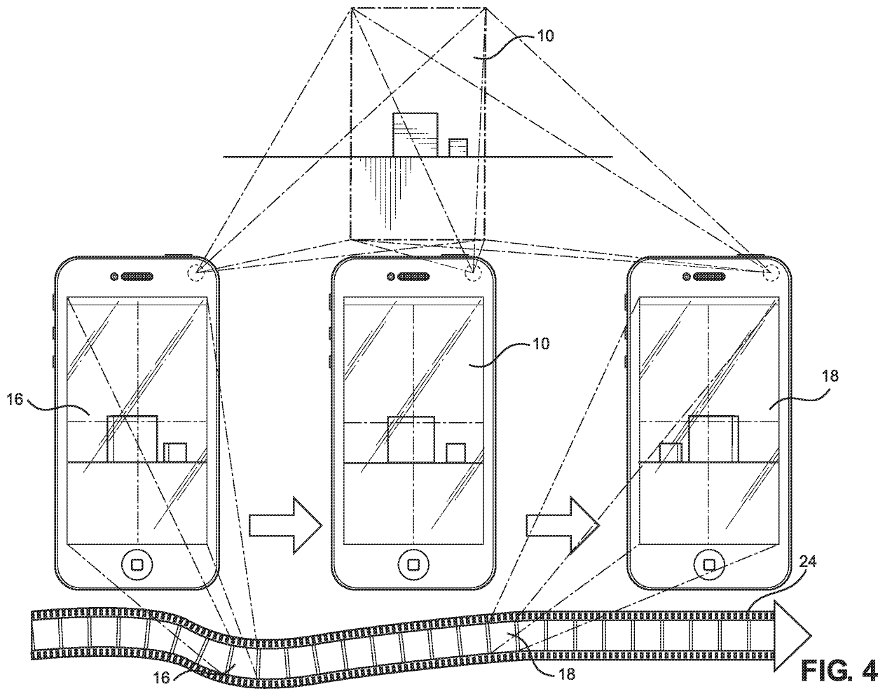

Specifically, the present invention embodies the following steps: downloading the systemic application on their smart device 12; framing a desired initial image capture 10 on the smart device's 12 user interface screen and capturing said initial image capture 10 at a selective focal point through the camera 14; while enabling the pan modality of the camera 14, the user selectively pans right and left relative to the focal point by a selective range (for example two to twelve inches to the left and the right of the initial image capture 10, respectively, to either side) , as illustrated in FIG. 2, whereby the camera captures two images as it pans past the framed initial image capture 10: a left eye perspective image and a right eye perspective image that the systemic application is enabled to composed into a left eye image 16 and the right eye image 18, respectively. The method contemplated by the present invention may include utilizing the video modality to capture the left and right eye perspective images on video 24, as illustrated in FIGS. 4 and 6, that the systemic application is enabled to composed into a left eye image 16 and the right eye image 18, respectively, and in turn to a composed stereo image 20. The systemic application then stores and processes the captured left eye image 16 and the right eye image 18, respectively, to be viewed later in one of any stereo imagery or three-dimensional formats as the stereo image 20, using the systemic application and the smart device's 12 computer and communication capabilities.

The ability to take and process two images (left eye image 16 and the right eye image 18) from left and right perspective eye images is the essential necessary element of the process, optional elements might include adjusting eye perspectives for better viewing, the number of stored frames for the computer to select from, the ability to zoom, conversion of existing panned ‘panorama’ photos to 3D, reformatting options; including the abilities to share on various communication formats and use in various viewing formats.

Modifications to synchronize the systemic application with possible future two lens, 3D cameras and smart phones would also be an option. Synchronizing with existing or future stereo or 3D video formats would also be an option. Embedding other information to be transmitted with the photo information would also be an option.

Additionally, the present invention could be used in any computerized photography system, and could also be used to create stereo images from collections of existing photos of panned or sequential photos such as photos from satellites as they traveled through space.

The countless smart device users, being able to take their own stereo photos with their pre-existing smart devices, would result in all sorts of products that would utilize the photos such as 3D sharing applications and platforms, new improved virtual reality viewers, print programs for stereo cards for antique 3D stereo scopes and Nickelodeon, Fresnel lens prismatic print options, future 3D smartphone screens and future capability programs for two lens camera/phone systems, and the like.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet 22. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented method for capturing stereo images using the single lens optics of any smart device without the use of any additional hardware, comprising:
providing a smart device having a camera;
selectively defining a focal point associated with an initial image capture by way of the camera;
capturing sequential images left and right of said focal point by a predetermined range through the camera, defining a left eye perspective image and a right eye perspective image of the initial image capture; and
composing said left and right eye perspective images into a left and right eye image, respectively, whereby said left and right eye image are configurable as a stereo image.

2. The method of claim 1, wherein the capturing of sequential images is from a pan mode of the camera.

3. The method of claim 1, wherein the capturing of sequential images is from a video mode of the camera.

4. The method of claim 2, wherein the predetermined range is between two and twelve inches.
